(19) United States
(12) Patent Application Publication
(10) Pub. No.: US 2026/0323183 A1
(43) Pub. Date: Oct. 15, 2026

(54) Imager with Dynamic LSB Adaptation and Ratiometric Readout for Low-Bit Depth 5-µW Peak Power in Purely-Harvested Systems

(71) Applicant: National University of Singapore, Singapore (SG)

(72) Inventors: Karim Ali AHMED, Singapore (SG); Longyang LIN, Singapore (SG); Praveenakumar Shivappa SALAMANI, Singapore (SG); Massimo ALIOTO, Singapore (SG)

(73) Assignee: National University of Singapore, Singapore (SG)

(21) Appl. No.: 18/873,125

(22) PCT Filed: Jun. 7, 2023
(86) PCT No.: PCT/IB2023/055896

§ 371 Date: Dec. 9, 2024

(30) Foreign Application Priority Data
Jun. 7, 2022 (SG) 10202250078Y

(51) Int. Cl. H04N 25/773; H04N 25/78

(52) U.S. Cl. CPC H04N 25/773; H04N 25/78

(57) ABSTRACT

An imager pixel comprising a forward-biased photo-detector with readout transistor for light-to-current conversion, and a ratiometric readout system comprising a current to pulse width converter. The readout system operates in a light mode to: generate a first current proportional to a photodetector current and a leakage current, on exposure to a photodetector voltage; and convert the first current to a first pulse width; and operates in a least significant bit (LSB) mode to: generate a second current proportional to a least significant bit (LSB) current and the leakage current, on exposure to a gate-source voltage; and convert the second current to a second pulse width. The system includes a converter circuit for converting the first pulse width to a count (CNTB) and the second pulse width to a further count (CNTA), and a counting circuit for providing a ratiometric readout based on a ratio of CNTB to CNTA.

### TECHNICAL FIELD

The present invention relates, in general terms, to imagers and, in particular but not limited to, pixels facilitating dynamic LSB adaption and ratiometric readout.

### BACKGROUND

Purely energy-harvested imagers enable battery suppression for low cost, small factor and long-lived sensor nodes for distributed vision systems, where image sensing and cloud AI sensemaking allow to capture visual data and generate valuable insights. To reduce power, aggressively low precisions were explored in AI accelerators (e.g., down to 4 bits). Similarly, low imager bit depths are being explored to narrow the gap. As a drawback, low bit depths N flatten visual features of interest under fluctuating lighting conditions. If the actual dynamic range in a scene is much smaller than the full-scale range FS (dark scene), most pixels are flattened into few bins with low intensity, and classification becomes hard under the comparatively large least significant bit (LSB)=FS/2N. Conversely, small and fixed LSB under scenes with large actual dynamic range (bright scene) poses the opposite issue, again misclassifying as most pixels are instead saturated to the highest value (FIG. 1).

It would be desirable to overcome or ameliorate at least one of the above-described problems, or to at least provide a useful alternative.

### SUMMARY

Described herein is a novel imager design with μW peak power for purely-harvested operation. The LSB is dynamically adapted to the light intensity of the scene for aggressive bit depth down-scaling, avoiding traditional dynamic range over-margining across practical light intensities under fixed LSB. Ratiometric readout of pixel current cancels threshold voltage mismatch. A 256×256-pixel 180-nm imager shows 5-μW power at 1 fps and 4 bits, while keeping ImageNet classification accuracy drop to percentage points under 75-dB ambient light range, across original and brightness-adjusted images.

An imager with dynamic LSB is proposed to enable low-bit depth sensing and extend the range of light conditions where the accuracy drop in image classification remains marginal from dark to bright (75-dB range, FIG. 1).

Disclosed is an imager pixel comprising:
a forward-biased photo-detector with readout transistor for light-to-current conversion;
a ratiometric readout system comprising a current to pulse width converter, for:
   operating in a light mode to:
      generate a first current proportional to a photodetector current and a leakage current, on exposure to a photodetector voltage; and
      convert the first current to a first pulse width; and operating in a least significant bit (LSB) mode to:
      generate a second current proportional to the least significant bit (LSB) current and the leakage current, on exposure to a gate-source voltage; and
      convert the second current to a second pulse width;
a converter circuit for converting the first pulse width to a count (CNTB) and the second pulse width to a count (CNTA); and
a counting circuit for providing a ratiometric readout based on a ratio of CNTB to CNTA.

Also disclosed is a system comprising:
a plurality of rows, each row comprising a plurality of pixels as described above, wherein the plurality of rows are separated into a plurality of clusters;
a row controller for, for a frame:
   sequentially operating the pixels in the clusters in LSB mode, light mode and averaging mode, and then idling the pixels until a next frame; and
   operating in averaging mode by averaging a pixel value across the frame to produce an average pixel value; and
a capacitor for each cluster for storing a voltage corresponding to the average pixel value for the cluster.

Advantageously, a forward-biased photo-detector with sub-threshold readout transistor can be provided. This enables nearly-linear light-to-current conversion.

Advantageously, embodiments provide a ratiometric readout with dual sensing mode. This mitigates threshold voltage mismatch—e.g. across the MPD.

Advantageously, embodiments provide cluster-level pipelining. This eliminates timing overhead due to dual sensing mode switching.

### BRIEF DESCRIPTION OF THE DRAWINGS

Embodiments of the present invention will now be described, by way of non-limiting example, with reference to the drawings in which:

FIG. 1 illustrates the limitations of conventional fixed LSB imagers at low bit depth;

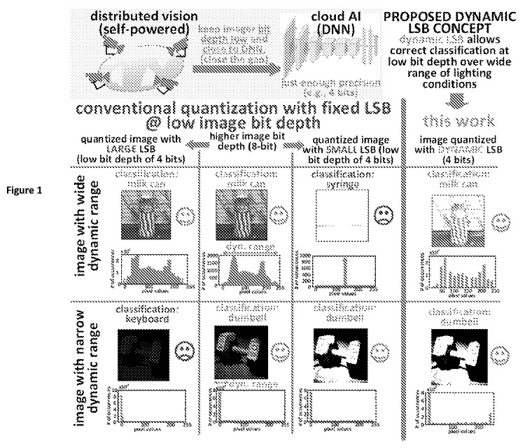

FIG. 2 schematically illustrates the dual sensing mode 12T pixel architecture and ratiometric readout scheme;

FIG. 3 shows an architecture of the proposed low bit-depth imager with dynamic LSB;

FIG. 4 is a timing diagram for cluster-level pipelining;

FIG. 5 shows the voltage threshold (VTH) mismatch map measured from CNTB/CNTA (uniform image, with & without ratiometric readout);

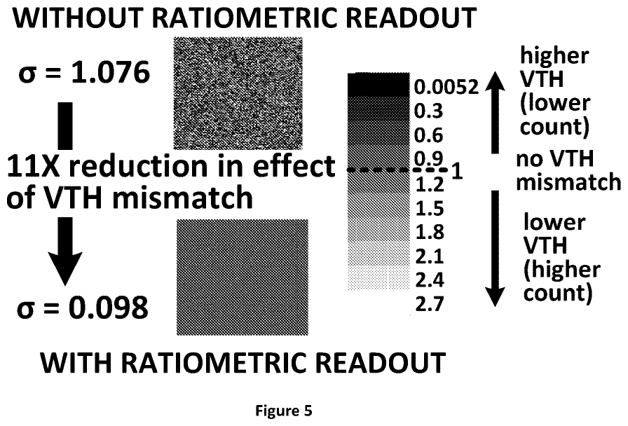

FIG. 6 shows the measured LSB pulse width (PWLSB) adaptation to light intensity (>75 dB);

FIG. 7 is an example of under harvesting: measured 1st image misclassification occurrence vs. brightness reduction; and

FIG. 8 shows the classification accuracy improvement of dynamic LSB over fixed LSB.

### DETAILED DESCRIPTION

Described herein are least significant bit (LSB) imagers that enable low-bit depth sensing and extends the range of light conditions where the accuracy drop in image classification remains marginal from dark to bright. It also enables operation at μW-range power for purely-harvested systems.

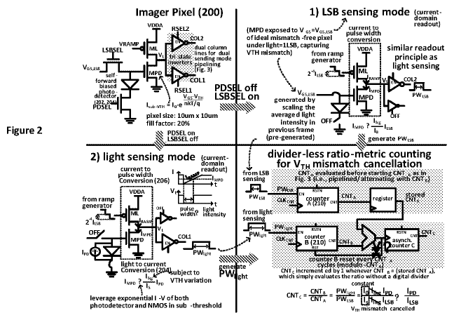

With reference to FIG. 2, an imager pixel 200 is provided. The pixel 200 comprises a forward-biased photo-detector 202 with sub-threshold readout transistor 204 for light-to-current conversion. The pixel 200 further comprises a ratiometric readout system 206, which comprises a current-to-pulse width converter. The imager pixel operates in light sensing mode and LSB sensing mode.

For the purpose of this discussion, “light sensing mode”, “light mode” and similar refer to when the photodetector is exposed to the photodetector voltage, and

“LSB sensing mode”, “LSB mode” and similar refer to when the photodetector is exposed to the gate-source voltage, obtained from a mismatch-free pixel exposed to a 1-LSB light intensity.

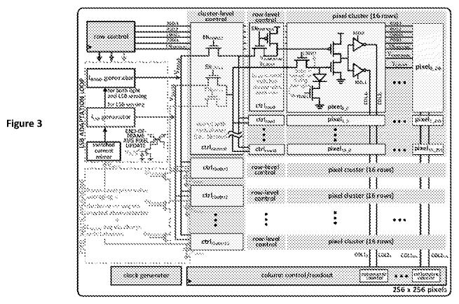

In light sensing mode, the MPD is exposed to the photodetector voltage. The MPD generates a first current (IMPD) proportional to a photodetector current (IPD) and a leakage current (Ilkg), on exposure to the photodetector voltage. MPD then converts the first current to a first pulse width PWlight, via in-pixel comparison with a current ramp (FIG. 3). PWlight is in turn converted to count CNTB based on the system clock.

In LSB sensing mode, the MPD is exposed to a gate-source voltage (V_{GS,LSB}). This generates a second current (I_{MPD}) proportional to a LSB current (I_{LSB}) and the leakage current (I_{lkg}). V_{GS,LSB} is produced by a mismatch-free (i.e. threshold voltage mismatch-free) pixel exposed to a 1-LSB light intensity, derived as proper fraction of the average light level across the frame. As above, the current I_{MPD} is converted to a pulse width PWLSB, then to count CNTA.

The pixel 200 further comprises a converter circuit 210 which converts the first pulse width PW_{light} to a count (CNTB) and the second pulse width PW_{LSB} to a count (CNTA). The pixel 200 also comprises a counting circuit for providing a ratiometric readout based on a ratio of CNTB to CNTA. Hence, the ratio PW_{light}/PW_{LSB}=CNTB/CNTA is independent of leakage and, accordingly, of the threshold voltage mismatch. With reference to FIG. 2, the ratio is evaluated digitally without a digital divider by using count CNTA in LSB mode as modulo of the CNTB in light mode, incrementing a third counter CNTC only every CNTA cycle, provided counter B keeps incrementing. The final value of counter C (CNTC) is hence CNTB/CNTA, enabling ratiometric readout.

Disclosed here is also a system comprising a plurality of rows, with each row comprising a plurality of pixels such as imager pixels 200 as described above (i.e. are rows of pixels), with the plurality of rows separated into a plurality of clusters. The rows may be clustered by proximity—e.g. every N neighbouring rows may form a cluster. Alternatively, pixels in the rows of pixels may be clustered together based on proximity—e.g. a pixel and its surrounding eight pixels (if the pixels are in a regular grid pattern) form a cluster—and thus any row may comprise pixels from multiple clusters.

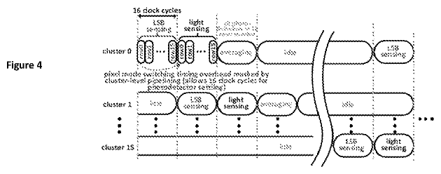

The system also comprises a row controller which sequentially operates the pixels in the clusters in LSB mode, light mode and averaging mode, then idles the pixels until the next frame. The row controller dynamically scales the LSB based on the average pixel value, generated from V_{avg}. With reference to FIG. 4, cluster-level pipelining masks the timing overhead of LSB to light mode switching. The row controller also operates in averaging mode by averaging a pixel value across the frame to produce an average pixel value. In cluster-level pixel averaging, photodetectors are shorted by the switch LSBSEL. Their cumulative current sets the aggregated photodetector voltage V_{cluster} to the value of a single photodetector with a current equal to their average. V_{cluster} IS then stored in a capacitor C_{cluster}, whose charge is progressively redistributed with the capacitors of subsequent clusters (i.e. clusters that are used subsequently in cluster-level averaging) when accessed, averaging V_{cluster} across clusters (FIG. 3). The resulting voltage V_{AVG} at the end of frame is the average open-circuit voltage of all photodetectors across the array. The system further comprises a capacitor for each cluster for storing a voltage corresponding to the average pixel value for the cluster.

Finally, V_{AVG} is applied to a properly sized pixel transistor replica MPD to generate the average pixel current IAVG. The LSB adaptation loop sets I_{LSB}=I_{AVG}/8 in 4-bit readout. The LSB adaptation loop also generates the corresponding V_{GS,LSB} for LSB mode. Moreover, the LSB adaptation loop may scale the ramp full-scale value to 2I_{AVG} to keep I_{AVG} at half the dynamic range. End-of-frame V_{GS,LSB} update transfers V_{AVG} from a storage capacitor to a switched-current mirror (FIG. 3).

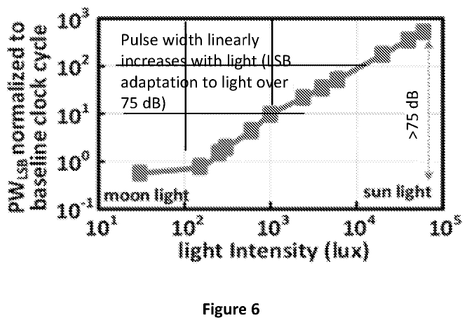

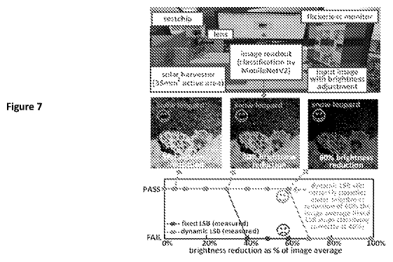

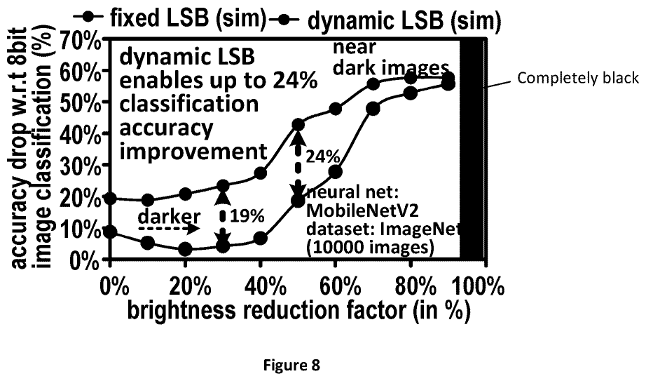

180-nm testchip measurements show that ratiometric readout reduces the mismatch-induced standard deviation of the digital output across pixels by 11× (FIG. 6). The LSB current I_{LSB} (measured by PW_{LSB} in FIG. 7) linearly tracks the scene light intensity over an ambient light range spanning>75 dB (average across frame from 15 to 60,000 lux), vastly exceeding the maximum 24 dB value of fixed LSB at 4-bit resolution. Using an example that employs direct harvesting (35-mm² solar cell, FIG. 8), dynamic LSB capture maintains correct MobileNetV2 neural network classification under lower brightness, compared to conventional fixed LSB. Iterating on a randomly sampled ImageNet dataset, dynamic LSB enables up to 24% better classification accuracy over fixed LSB in dark scenes (FIG. 9).

Table I provides a performance comparison with prior imager technologies. The proposed imager with dynamic LSB enables operation at μW-range power for purely-harvested operation, thanks to the lowest 0.08 nW/pixel power that is 3.75-47.5× lower than known pixel powers that have the lowest bit depth, and by three orders of magnitude over higher-bit depth imagers. In spite of retaining linear mapping, the >75-dB ambient light range is substantially higher than the logarithmic imager by 15.7 dB, without requiring imager-specific process as in the 16×10 array at 8-10 bit (ISSCC'18).

TABLE I
Performance summary (best or unique performance is in bold)

| | Present | | | | |
|---|---|---|---|---|---|
| | technology | ISSCC′19 | VLSI′20 | ISSCC′18 | JSSC′20 |
| technology | 180 nm | 130 nm | 90 nm | 90 nm | 90 nm BSI |
| unique features | dynamic LSB | compressive | on-chip | sensing | on-chip back- |
| | | log gradient | motion | pinning | ground light |
| | | | detection | mode | cancellation |
| area (mm × | 4.1 × 4.1 | 4 × 4 | 1.8 × 4.4 | 4.9 × 4.4 | 3.4 × 4.8 |
| mm) | | | | | |
| resolution | 256 × 256 | 320 × 240 | 160 × 120 | 16 × 10 | 320 × 240 |
| pixel type | custom 12T | standard 4T | standard 4T | shared 1.5T | pseudo 4 tap |
| pixel size | 10 × 10 | 5 × 5 | 3.2 × 3.2 | 1.5 × 1.5 | 8 × 8 |
| (μm × μm) | | | | | |
| pixel size | 55 × 55 | 38 × 38 | 35 × 35 | 16 × 16 | 88 × 88 |
| (F × F) | | | | | |
| frame rate (fps) | 1-5 | 30 | 5 | 10-60 | 10-60 |
| bit depth | 4 b | 2.75 b | 4 b/6 b | 8 b/10 b | 10 b |
| linear mapping | YES | NO | NO | YES | YES |
| photo diode ^{b} | FB | RB | RB | RB | RB |
| ambient light | >75 | 59.3 | 88.3 | 96 | — |
| range (dB) | | | | | |
| supply voltage | 1.4 (analog) | 3.3 (analog) | 1.6 (analog) | 1.8 (analog) | 1.8 (analog) |
| (V) | 0.6 (digital) | | 0.8 (digital) | 1 (digital) | 1.2 (digital) |
| power (μW) | 5.3 @ 1 fps | 292 | 5.7 @ 6 b | 1,100 @ 8 b | 223,000 |
| energy/(pixel × | 80 | 127 | 59 | 347 | 48,394 |
| frame) (pJ) | | | | | |

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. An imager pixel comprising:
a forward-biased photo-detector with readout transistor for light-to-current conversion;
a ratiometric readout system, comprising a current-to-pulse width converter, for:
operating in a light mode to:
generate a first current proportional to a photodetector current and a leakage current, on exposure to a photodetector voltage; and
convert the first current to a first pulse width; and
operating in a least significant bit (LSB) mode to:
generate a second current proportional to a least significant bit (LSB) current and the leakage current, on exposure to a gate-source voltage; and
convert the second current to a second pulse width;
a converter circuit for converting the first pulse width to a count (CNTB) and the second pulse width to a further count (CNTA); and
a counting circuit for providing a ratiometric readout based on a ratio of CNTB to CNTA.

2. The pixel of claim 1, wherein the readout transistor is a sub-threshold readout transistor.

3. The pixel of claim 1, wherein the first pulse width and second pulse width are proportional pulse widths generated by in-pixel comparison with a ramp current.

4. The pixel of claim 1, wherein the gate-source voltage corresponds to a mismatch-free pixel exposed to a 1-LSB intensity light.

5. The pixel of claim 4, wherein the mismatch-free pixel exposed to a 1-LSB intensity light is derived as a proper fraction of an average light level across a frame.

6. The pixel of claim 1, wherein the ratio is determined by using CNTA in LSB mode as modulo of CNTB in light mode, and incrementing a counter C every CNTA cycles over which CNTB increments.

7. A system comprising:
a plurality of rows, each row comprising a plurality of pixels according to claim 1, the plurality of rows forming an array, wherein the plurality of rows are separated into a plurality of clusters;
a row controller for, for a frame:
sequentially operating the pixels in the clusters in LSB mode, light mode and averaging mode, and then idling the pixels until a next frame; and
operating in averaging mode by averaging a pixel value across the frame to produce an average pixel value; and
a capacitor for each cluster for storing a voltage corresponding to the average pixel value for the cluster.

8. The system of claim 7, wherein the row controller dynamically scales the LSB based on the average pixel value.

9. The system of claim 7, wherein the row controller averages the pixel value across the frame by:
performing a first averaging process by averaging a pixel value within each cluster to produce a cluster-level average pixel value, and storing a voltage corresponding to the cluster-level average pixel value in the capacitor corresponding to the respective cluster; and
performing a second averaging process by progressively averaging the cluster-level average pixel values across the clusters.

10. The system of claim 9, wherein the row controller shorts the photodetectors of each pixel in each cluster involved in the second averaging process.

11. The system of claim 9, wherein the second averaging process involves progressively averaging the cluster-level average pixel values across the clusters by progressively redistributing the voltage from each cluster across the capacitors of subsequent clusters when progressively averaging.

12. The system of claim 7, wherein the row controller produces an average open-circuit voltage of all photodetectors across the array (V_{avg}) based on the voltages, each voltage corresponding to the average pixel value for a respective said cluster.

13. The system of claim 7, wherein the row controller:
generates an average pixel current value from V_{avg}; and
sets the LSB current, generates the gate-source voltage, and scale a ramp current, based on the average pixel current value.

14. The system of claim 13, wherein, after processing the frame, the gate-source voltage transfer V_{avg} to a switched-current mirror for processing a next frame.
